(19) United States
(12) Patent Application Publication
(10) Pub. No.: US 2014/0372483 A1
(43) Pub. Date: Dec. 18, 2014

(54) SYSTEM AND METHOD FOR TEXT MINING

(71) Applicant: Copyright Clearance Center, Inc., Danvers, MA (US)

(72) Inventors: Babis Marmanis, Waltham, MA (US); Skott Klebe, Lexington, MA (US); John Billington, Georgetown, MA (US)

(21) Appl. No.: 14/307,749

(22) Filed: Jun. 18, 2014

Related U.S. Application Data
(60) Provisional application No. 61/836,407, filed on Jun. 18, 2013.

(51) Int. Cl. G06F 17/30

(52) U.S. Cl. CPC G06F 17/30539; G06F 2216/03
USPC 707/776

(57) ABSTRACT

A multi-user system for text mining a large population of research documents in an efficient and cost-effective fashion includes a content repository, a text mining processor, and a derived data repository that are linked via a user-accessible, central project manager. The content repository includes a data storage device for storing the research documents and a content selection facility for receiving a user-defined query that is able to support cost-related search parameters. The query is utilized by the content selection facility to select an initial collection of documents from the data storage device. Content spread metrics are then displayed through user-intuitive reports to allow for subsequent modification of the search query to yield an optimized document collection. The optimized document collection is then parsed, tagged and clustered by the text mining processor to produce search results that are stored as a data set in the derived data repository.

### FIELD OF THE INVENTION

The present invention relates generally to published research documents in the fields of science, technology and medicine and more particularly to systems and methods for text mining research documents in a comprehensive yet efficient manner.

### BACKGROUND OF THE INVENTION

Every year, tens of millions of scholarly documents are published worldwide. The majority of these published documents, or articles, are electronically available for review by researchers, with access to certain articles being rendered at no cost and access to other articles being rendered at a fee designated by the entity that owns the rights to each document.

Due to the voluminous amount of information electronically available on certain research topics, it is often difficult for researchers to comprehensively, yet efficiently, search through the continuously increasing amount of electronic information on the subject. In particular, it has been found that traditional search engines are poorly suited for use in searching research documents because, inter alia, the specification and processing of selection criteria, while effective in evaluating a small number of documents for relevancy, is ill-suited for the purpose of selecting from a large quantity of documents that all fit very specific criteria. As a result, the enormous amount of information that is electronically available on certain subjects is so large that a researcher is often at risk of failing to locate pertinent documents, which is highly undesirable.

Accordingly, in order to assist researchers in searching through the vast number of published articles, it has become increasingly customary for organizations (e.g., publishers and rights management services) to create software and databases that allow for the parsing and extraction of high-quality data from the text of research documents through a process known in the art as “text mining.” Through the text mining process of parsing, analyzing and cross-referencing text from millions of documents, pertinent publications are more effectively able to be identified by researchers using computer-based searching tools.

The process of effectively text mining published research documents poses many challenges and currently carries certain limitations.

As a first challenge, the effective text mining of published research documents initially requires collecting large relevant corpora of documentation. Specifically, to enhance comprehensiveness, the text mining of scientific research requires access to as many research articles as possible. At the same time, the owner of the rights to a collection of research documents is often hesitant to grant access to documents for text mining purposes due to the risk of unauthorized article duplication and dissemination, thereby precluding the owner from potentially generating revenue from the documents through subscriptions and other traditional forms of purchased access. To limit the risk of any unauthorized copying of articles, publishers often provide articles for text mining purposes in randomized form (e.g., with sentences or words arranged alphabetically). However, it has been found that randomized articles limit certain text mining functionality (e.g., the ability to differentiate between a survey paper and the record of an experiment based on identified writing patterns) and, therefore, this practice has been found not to be ideal.

As a second challenge, text mining of published research documents does not currently take into account the implication of cost to the end-user. As noted above, different articles carry different costs for access. As a result, a researcher with a limited search budget may opt to restrict a search to no-fee publications and thereby risk locating a pertinent document. Likewise, a researcher with a limited search budget who opts to expand the search field to numerous publications, including publications which require a fee for document access, is often burdened with a research cost that is excessive and prohibitive.

As a third challenge, effective text mining of published research documents requires that search results provide the end user with access to the entirety of the texts of the large population of documents. By contrast, traditional search engines return only a list of links to individual articles together with limited contextual information for human evaluation, which has been found to be inadequate for a researcher in determining the relevance of each article.

As a fourth challenge, text mining of published research documents does not currently provide the end user with any useful query information regarding the search results. Rather, the end user generally has limited data to determine why certain documents were retrieved during a primary search. As such, the end user is precluded from using information from a previous search to improve the overall effectiveness of a future search.

### SUMMARY OF THE INVENTION

It is an object of the present invention to provide a new and improved system and method for text mining research documents.

It is another object of the present invention to provide a system and method for text mining research documents in a comprehensive and cost-effective manner.

Accordingly, as one feature of the present invention, there is provided a system for facilitating the text mining of a plurality of research documents by a user, the plurality of research documents carrying a non-uniform cost for access by the user, the system comprising (a) a content repository adapted to store the plurality of research documents, the content repository being adapted to receive a query from the user to select a primary collection of the plurality of research documents for text mining, the content repository providing content spread metrics relating to the research documents in the primary collection that enables the user to optionally modify the query to yield a final collection of the plurality of research documents that is optimized for the user, and (b) a text mining processor for text mining the final collection of research documents to produce a derived text mining data set.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of a system for text mining documents, the system being constructed according to the teachings of the present invention;

FIG. 2 is an exemplary data model that is useful in understanding an implementable relationship between the various forms article-related data stored in the content repository shown in FIG. 1;

FIG. 3 is an exemplary data model that is useful in understanding an implementation for article access domain within the document repository shown in FIG. 1;

FIG. 4 is a simplified flow chart of a novel method of text mining documents using the system shown in FIG. 1;

FIG. 5 is a more detailed flow chart of the text mining method shown in FIG. 4;

FIG. 6 is shown an exemplary data model that is useful in understanding an implementable relationship of the spread metric-related data stored in the content selection facility shown in FIG. 1; and

FIGS. 7(a)-(e) are a series of sample screen displays which are useful in understanding an illustrative use of the system shown in FIG. 1.

### DETAILED DESCRIPTION OF THE INVENTION

### Text Mining System 11

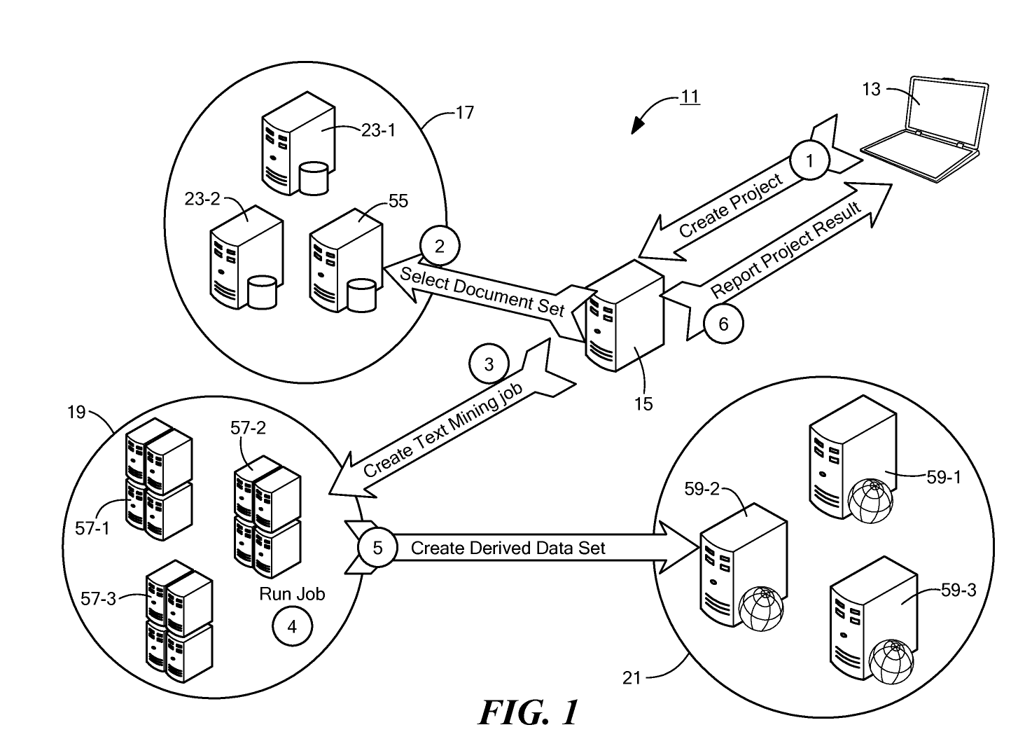

Referring now to FIG. 1, there is shown a general block diagram of a system for text mining research documents, the system being constructed according to the teachings of the present invention and identified generally by reference numeral 11. As will be explained further in detail below, system 11 is designed, inter alia, to (i) incorporate cost parameters into the process of selecting a collection of research documents that is to be the subject of a subsequent text mining operation and, in turn, (ii) provide user-intuitive metrics relating to the spread of the selected documents. If necessary, the user can then utilize the metrics to modify certain parameters of the document selection process in order to yield an optimized collection of research documents to be text mined. In this capacity, system 11 promotes the text mining of a comprehensive, yet cost-effective, collection of research documents, which is a principal object of the present invention.

For illustrative purposes only, system 11 is described herein in connection with text mining operations conducted using a large repository of research documents. However, it is to be understood that system 11 is not limited to the text mining of research documents. Rather, it is to be understood that system 11 could be used in any environment which requires the identification of relevant text from any type of document, particularly any document which carries a fee for access thereto.

System 11 includes a plurality of modules that together provide to an end user 13 the text mining operations of the present invention. Specifically, as will be described in detail below, system 11 comprises a project manager 15 which serves as the central, functional hub of system 11, a document repository 17 that contains articles for text mining and metered access, a text mining processor 19 that performs the principal text mining operations of the invention, and a derived data repository 21 that stores the output of text mining operations conducted by text mining processor 19.

Project manager 15 is represented herein as a server that is electronically linked with a compute device for end user 13 via any communication medium (e.g., via the internet). In this manner, project manager 15 provides to end user 13 the primary interface for accessing system 11. As will be described further below, project manager 15 allows end user 13 to (i) create new text mining projects, (ii) track the status and progress of ongoing projects, and (iii) access data returned by completed projects.

It should be noted that access to text mining projects can be granted from project manager 15 to a given end user 13 on either an individual, team-based, or institutional level of access rights. In this capacity, it is envisioned that system 11 could be implemented in a wide variety of different environments.

Document, or content, repository 17 comprises data storage devices 23-1 and 23-2 that contain both bibliographic metadata and full text of a large population of scholarly articles, with the content preferably indexed to facilitate rapid retrieval.

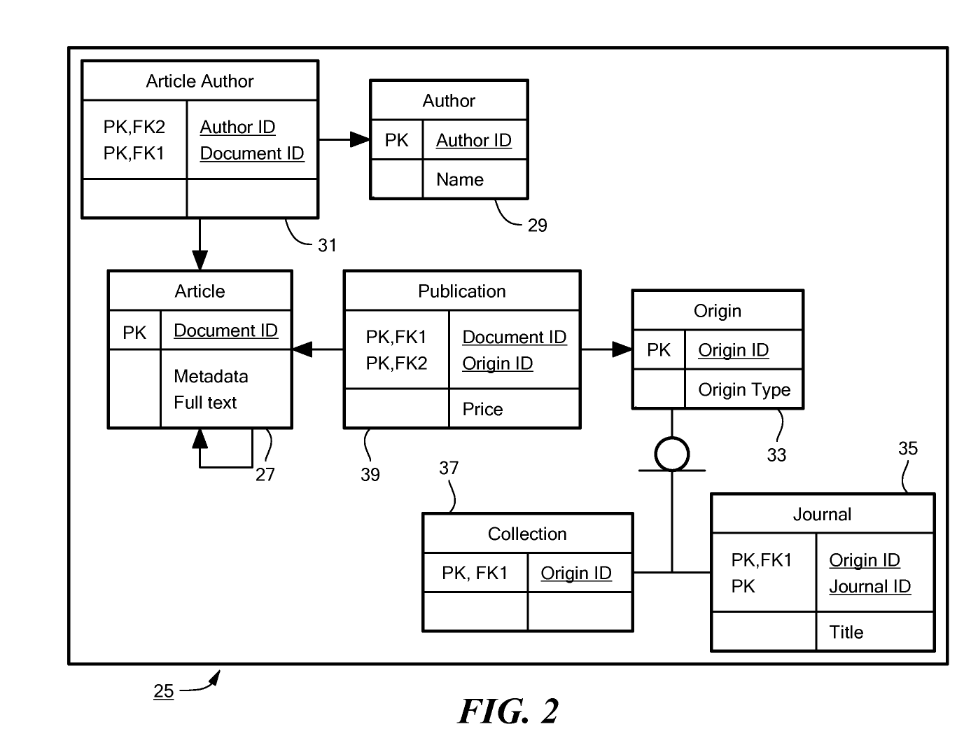

For instance, referring now to FIG. 2, there is shown an exemplary data model that is useful in understanding an implementable relationship between the various forms article-related data stored in content repository 17, the data model being identified generally by reference numeral 25. However, it is to be understood that analogous data models in other database technologies could be similarly constructed by an experienced practitioner of database modeling without departing from the spirit of the present invention.

As can be seen, data model 25 includes an article table 27 with metadata for each article that comprises, but is not limited to, the title of the work, the author of the work, and certain keywords. Article table 27 preferably additionally includes full text for each article (i.e., the complete textual matter constituting the published form of the document) as well as a bibliography, a list of citations, and/or reference to another set of articles that may or may not be located in repository 19.

An author table 29 is linked to article table 27 (via article author table 31) and represents the various individuals or organizations that create scholarly documents. Preferably, authors appear in document repository 17 by name and with an optional set of standard identifiers.

An origin table 33 provides data relating to a generic source for articles (i.e., where an article can be found). Journals (i.e., scholarly works that publish sets of articles) and repositories are both types of origins. Accordingly, a journal table 35 is linked with origin table 33, with attributes of each journal, including title, standard numbers, and publisher, appearing therein. Similarly, a collection table 37 is linked with origin table 33, and provides an alternative source of articles, with articles potentially appearing in both journals and collections.

Lastly, a publication table 39 establishes a relationship between the data in article table 27 and origin table 33. Publication table 39 includes data that denotes article availability directly from the publisher, often at a higher price. For example, a particular article might be available from its original publisher for $40.00, and from a document repository for $5.00.

Accordingly, using the structure of exemplary data model 25, it is clear that search queries could be readily processed using data relating to, among other things, (i) an author or a set of authors, (ii) an article title, (iii) keywords or other similar metadata fields, (iv) a publication or a set of publications, (v) a journal or a set of journals, (vi) a collection or a set of collections, and/or (vii) a range of publication dates.

It is to be understood that at least one data storage device 23 additionally includes a database of user access rights. Accordingly, document repository 17 is able to track access rights for each user, depending upon entitlements, and in turn log access at the article level by query, job, and user.

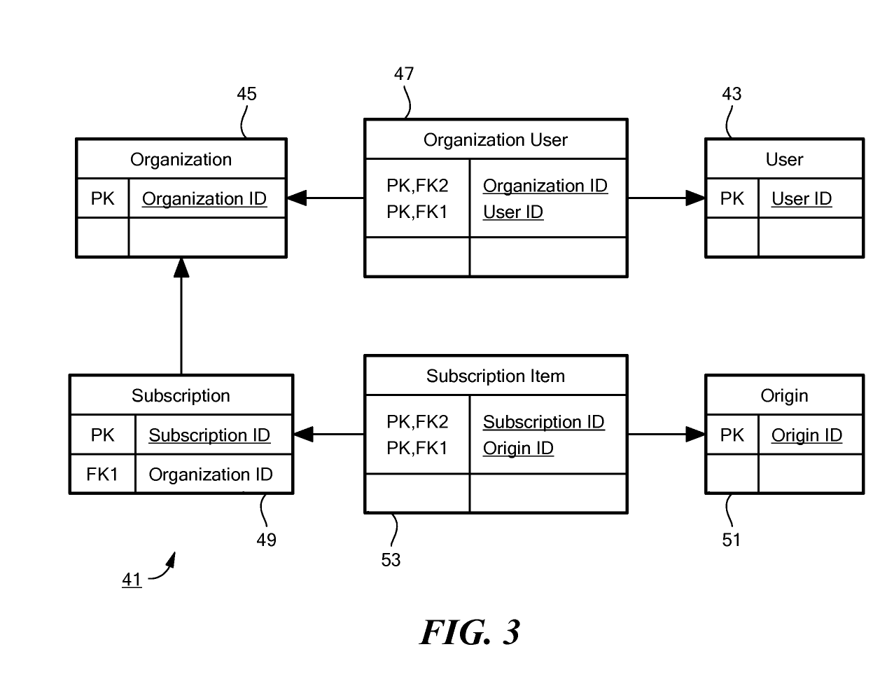

For instance, referring now to FIG. 3, there is shown an exemplary data model that provides an implementation for article access domain within document repository 17, the data model being identified generally by reference numeral 41. As can be seen, data model 41 cross-references an end user table 43 with an organization table 45 (via organization user table 47), since each organization typically includes a number of different users. Furthermore, because an organization often purchases multiple subscriptions, organization table 45 is linked with a subscription table 49. An origin table 51, which defines the source of articles (i.e., different collections in which articles are available for purchase), is then linked with subscription table 49 via subscription item table 53. Consequently, system 11 not only enables end user 13 to effectively text mine through the large quantity of articles contained within document repository 17 but also readily ascertain to which articles each end user 13 has a subscription, which is highly desirable.

Referring back to FIG. 1, document repository 17 additionally includes a content selection facility, or query processor, 55 that is in communication with both data storage devices 23 and project manager 15. Accordingly, as will be described further below, content selection facility 55 accesses research documents from data storage devices 23 and selects optimized subsets, or clusters, of articles by performing a variety of different full text and metadata queries. The resulting document clusters are then stored by content selection facility 55 to facilitate future queries, with these document clusters being updated, as needed, when the original query is repeated.

As principal features of the present invention, content selection facility 55 is capable of incorporating cost parameters into full text and metadata queries to yield an initial population of documents from data storage devices 23. Additionally, content selection facility 25 provides end user 13 with intuitive metrics relating to the spread of the selected documents obtained from an initial query. In this manner, the user can refine the query, as needed, to yield a comprehensive, yet cost-effective, spread of research documents to be subsequently text mined, as will be explained further below.

As referenced briefly above, text mining processor 19 is responsible for the principal text mining operations of the present invention. In other words, text mining processor 19 allows the researcher to specify a text mining job over an associated collection of documents retrieved from repository 19, executes the job asynchronously to the job request, and then notifies the researcher upon completion.

As represented herein, text mining processor 19 comprises a plurality of stacked compute devices 57-1 thru 57-3 that have been designed to execute text mining programs in parallel according to standardized architecture. Specifically, the text mining software accepts input data from compute devices 59-1 thru 59-3 in derived data repository 21 (i.e., the output of previous text mining operations) and performs text mining operations in parallel, over document metadata and full text, for collections specified in document sets to yield an output that is then stored in named data sets in derived data repository 21. Preferably, the allocation of processing resources directed to each job is internally tracked by text mining processor 19.

### Text Mining Method 111 Using System 11

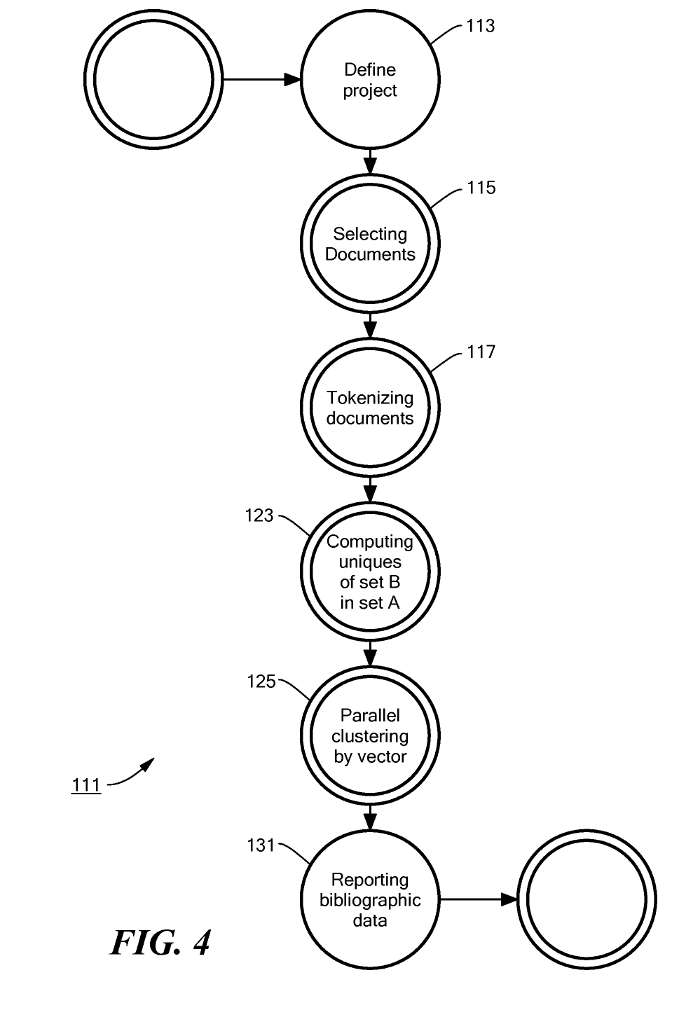

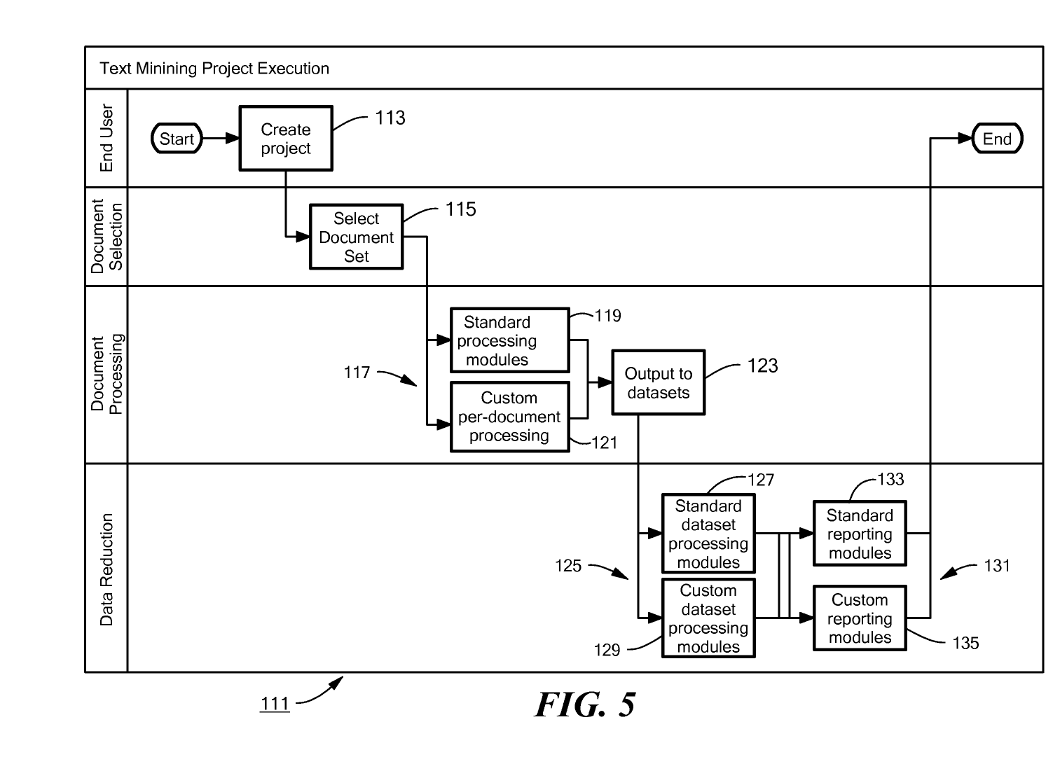

As referenced briefly above, system 11 is designed to engage in a novel method of text mining research documents. Specifically, referring now to FIGS. 4 and 5, there are shown simplified and slightly more detailed flow charts, respectively, of a novel method of selecting, purchasing, and processing documents for text mining using system 11, the method being identified herein generally by reference numeral 111.

As will be described further in detail below, the text mining method of the present invention initially collects a population, or pool, of research documents using a set of search variables, or parameters, to yield a wide collection of potentially relevant research documents. In other words, the initial collection does not seek to return documents prioritized by relevance for human selection, as if attempting to find a single document that best fits the query criteria. Instead, the result set is not presented for examination, but rather gathered for a subsequent text mining process.

The aforementioned document selection process is analogous to throwing a “fence” around a number of articles to form a collection subset. The configuration of the fence can then be subsequently modified by the user using content spread metrics (i.e., information as to why certain articles were initially selected) to redefine or narrow down the original pool of research documents to a selection most appropriate and desirable for end user 13 (e.g., by cost, publisher, etc.). In this manner, a high quality selection of research documents, all of which obey certain characteristics, is gathered for a subsequent text mining operation in an efficient and cost-effective fashion.

It should be noted that text mining jobs consist of program code that is uploaded to project manager 15.

To commence process 111, end user 13 first defines, or creates, a text mining project, the project defining step being identified generally by reference numeral 113. Specifically, as part of project defining step 113, end user 13 specifies (i) the document set (i.e., the selection of content in repository 19) to be utilized in the text mining operation, (ii) the process specification (i.e., the tokenization of documents, the computation of unique attributes, and the parallel clustering of similar data structures), and (iii) the reporting specification (i.e., the particular means for presenting the text mining results to the user).

It should be noted that the document set can be specified either (i) through a document query that uses specifications, such as document identifier, author, collaborator, institution, and publisher (or any lists or collections of the aforementioned attributes), or (ii) by using a predefined document set (i.e., a document set resulting from a previous inquiry).

Upon completion of step 113, content selection facility 55 selects the research documents for the job, honoring any content spread constraints specified in step 113 (e.g., locate all documents that contain the term, “C. Elegans” but exclude articles from Publisher X), the document selection step being identified generally by reference numeral 115.

As part of document selection step 115, system 11 generates a user interface that enables end user 13 to identify and analyze the spread metrics associated with an initial collection of documents. In this capacity, end user 13 can modify certain parameters of the primary query to yield a more optimized collection of documents to be text mined.

By contrast, the results of traditional text-based searches are not typically explained. In other words, the user does not generally understand why search results are located and ranked in a particular order. However, in the research field, researchers cannot utilize an arbitrary selection of content from a search request. Due to the availability of a voluminous amount of research articles, researchers need to know why certain articles are selected and, more importantly, how to modify the importance, or details, of the search parameters to affect the search results.

Accordingly, as referenced briefly above, query processor 55 generates reports for the user based upon selected search metrics (i.e., a breakdown of search results, by content, publishers, cost, etc.). In this manner, end user 13 is better able to determine the factors that influenced search results. In turn, system 11 enables end user 13 to then adjust the search parameters on the fly and conduct a subsequent, secondary collection of documents to accommodate any detected inefficiencies in the primary collection.

With an expansive population of research documents initially collected in step 115, a document processing step begins to define, or identify, an optimized group, or subset, of documents therein (i.e., documents most similar with respect to the particular keywords identified), the document processing step being identified generally by reference numeral 117.

Document processing step 117 preferably utilizes a variation of the pipelined map reduce paradigm that is used in batch processing of large datasets. Preferably, text mining processors 19 provide application programming interfaces (APIs) for developing custom map and reduce modules.

Specifically, “map” processes can be specified that perform operations on individual documents to transform each document into other forms. For instance, a process may transform papers describing gene sequencing research into lists of specific genes mentioned by each paper.

Furthermore, “reduce” processes combines lists of transformed documents into aggregated forms. For instance, a process may take a list of genes mentioned by a collection of research papers and, in turn, return a list of genes that is aggregated by the institutions performing the research. A second stage of reduce transforms can operate over the outputs of the first stage, taking sets of genes by institution and repeating the aggregation by institution. This is called a “join” transformation. Splitting the processing in this way helps support parallelization of the execution of the job.

As a novel feature of the present invention, document processing step 117 supports both standard processing modules 119 as well as custom processing modules 121, the outputs from which are further processed to find unique attributes, as will be explained further below.

Standard processing module 119 is provided by text mining processor 19 for use by all end users 13. Examples of standard processing modules 119 include, in order of increasing specialization to the research task, (i) tokenization (i.e., the parsing, or splitting) of an article into a hierarchy of sections, paragraphs, sentences, and words, (ii) part of speech tagging (i.e., identifying words as a nouns, verbs, etc.), (iii) citation extraction (i.e., transforming article bibliographies into lists of article metadata or article references), and (iv) gene extraction (i.e., tagging word forms in articles according to HUGO gene nomenclature system, such as HOXA1, BRCA1, etc.).

Custom processing module 121 is created by a particular end user 13 for repeated use and is implemented as a program according to the module application programming interface (API). As a feature of the invention, custom processing module 121 can either be reserved for personal use by the end user responsible for its creation, or published for widespread use by all end users 13 in an anonymous or named fashion. It is to be understood that a custom processing module 121 that is frequently utilized by many customers may impart special privileges or financial advantages to its creator.

Once the initial collection of documents has been parsed, tagged, and/or transformed by text mining processing modules 119 and 121, unique, user-specified attributes are then identified to form datasets 123. Datasets 123 are then further reduced during a data reduction, or collection processing step 125 that clusters relevant data in parallel, as will be explained further below.

Data reduction step 125 augments modules 119 and 121 by accessing a standard dataset processing module 127 and a custom dataset processing module 129 to yield standard datasets and custom datasets, respectively.

Standard datasets are collections of data in pairs (i.e., by name, value) that, in turn, can be accessed by name by any module. Examples of standard datasets include, but are not limited to, ISO country codes, HUGO gene nomenclature, and the periodic table of the elements.

Custom datasets are like standard datasets, but are contributed by individual end users 13 of system 11. Like custom modules, custom datasets can either be reserved for personal use, or published, either anonymously or by name, for use by all end users 13 of system. Once again, it is to be understood that a custom dataset that is frequently utilized by many customers may impart special privileges or financial advantages to its creator.

Dataset processing modules 127 and 129 are combined into pipelines, or clusters. The output of modules 127 and 129 can flow directly into another dataset processing module, or the outputs of several dataset processing modules can be combined using aggregation and filtering operations.

Upon completion of the parallel clustering of relevant data in step 125, the results of the text mining operation are reported to user 13 as a part of reporting step 131. In reporting step 131, standard and custom reporting modules 133 and 135 generate bibliographic data for the documents deemed most pertinent from the text mining operation, the bibliographic data being stored as a derived dataset in repository 21. This derived dataset is then available to be retrieved and examined by end user 13 during the course of research via project manager 15.

### Costing Module of Content Selection Facility 55

As referenced briefly above, content selection facility 55 enables end user 13 to engage in an interactive content selection process that ensures that an optimized collection of documents is retrieved for text mining. As a feature of the present invention, content selection facility 55 is capable of refining, or optimizing, the initial population of documents retrieved from full text and metadata queries using a novel costing module. In other words, content selection facility 55 is programmed to enable end user 13 to select a pool of articles (e.g., based on certain keywords, by article language and/or by certain authors) while factoring into account article access costs (i.e., to which articles does the user have subscriptions, what is the maximum search budget, etc.).

As can be appreciated, the selection of cost-based document collections can impose significant financial challenges to researchers. In particular, document repository 17 preferably contains, or has access to, the text of numerous articles to which user 13 does not have a subscription, but which are available upon paying a requisite access fee. However, given that traditional text mining processes typically provide an end user with to access many more documents than the researcher would, or could, be willing to read, a document selection query that is insufficiently precise could be cost-prohibitive to exercise.

Accordingly, content selection facility 55 is provided with a costing module that can be used, inter alia, to set and honor a maximum content cost for each text mining job, while in the presence of additional search constraints.

To set a maximum content cost for a text mining job, the following formula may be utilized by content selection facility 25:

ΣᵢⁿF(dᵢ), (1)

where n is the number of documents in the collection, and F(d) is the function that determines the cost of obtaining each document d, as determined in the exemplary schema from publication table 39 (i.e., without factoring existing article subscriptions/purchases).

However, equation (1) fails to take into account the documents that a user is already entitled to access. It is also useful to take into account that different origins (i.e., sources) for documents will offer different average prices, but, at the same time, every origin will not offer every document. For instance, a document may be available (i) at no cost from origins to which the user has an existing subscription, (ii) at a low, flat rate from public document repositories, such as the JSTOR® digital library, and (iii) at a relatively high rate from individual publishers. Accordingly, a more useful expression of the costing formula to be utilized by content selection facility 55 would take into account the sum of all the different costs for each article when taken from all available origins, as represented below:

Σⱼ⁰Σᵢ^{nD}Fⱼ(Dᵢ), (2)

where n is the number of documents in the collection, and F(d) is the function that determines the cost of obtaining each document d from each origin j, as determined in the exemplary schema from publication table 39.

Utilizing equation (2), a maximum content cost, or budget, B for a text mining job can be established by adding a constraint to the query set, as represented below:

Σⱼ⁰ΣᵢⁿFⱼ(dᵢ)<B (3)

Optimally, text mining research seeks to maximize the pool of selected research documents in order to reduce anomalies and otherwise increase the statistical reliability of results. One way to satisfy budget constraints, while, at the same time, maximize the document population, is to sort the articles within the collection by increasing cost. The articles are then selected, in order, until the collected set of articles reaches the defined budget.

However, the utilization of an increasing-cost selection process, as described above, is largely insufficient for the requirements of many research jobs, especially when the universe of documents consists of many pools of distinctly different per-article costs. Most notably, budget-constrained selections would be heavily weighted toward free content, content subscribed by the user, as well as older content in public repositories, thereby yielding search results that include a large quantity of less reliable and relevant documents.

The present invention therefore includes mechanisms for specifying and selecting populations of articles that honor the content spending constraint while, at the same time, avoiding unfair allocations to particular no-cost and low-cost origins or other metadata field values.

As defined herein, the term “content spread” denotes the extent to which a population of documents is widely distributed among a particular qualifier, such as by origin. For instance, a population of research documents with fair representation among many different sources, including both free and paid, and with collections from a variety of different publishers, would be considered a relatively wide, or broad, content spread.

Upon completion of the initial collection of documents by content selection facility 55, but prior to the actual scheduling and execution of a corresponding text mining job, content selection facility 55 calculates content spread using a variety of predefined metrics, or rules. In turn, content selection facility 55 displays the calculated content spread through one or more user interface (UI) review screens. In this manner, end user 13 is able to analyze content spread across a variety of metrics (e.g., cost, sources, etc.,) and, if necessary, modify search parameters to yield an adjusted document collection set prior to scheduling the text mining operation.

Metrics of content spread can support configurable warning thresholds and user messaging to ensure that an optimized collection of documents is utilized during the subsequent text mining operation. In addition, the user can investigate content spread among a variety of different attributes of documents in the collection by selecting an attribute and an aggregate function, such as sum or average. In turn, content selection facility 55 calculates the aggregates across the elements of the set.

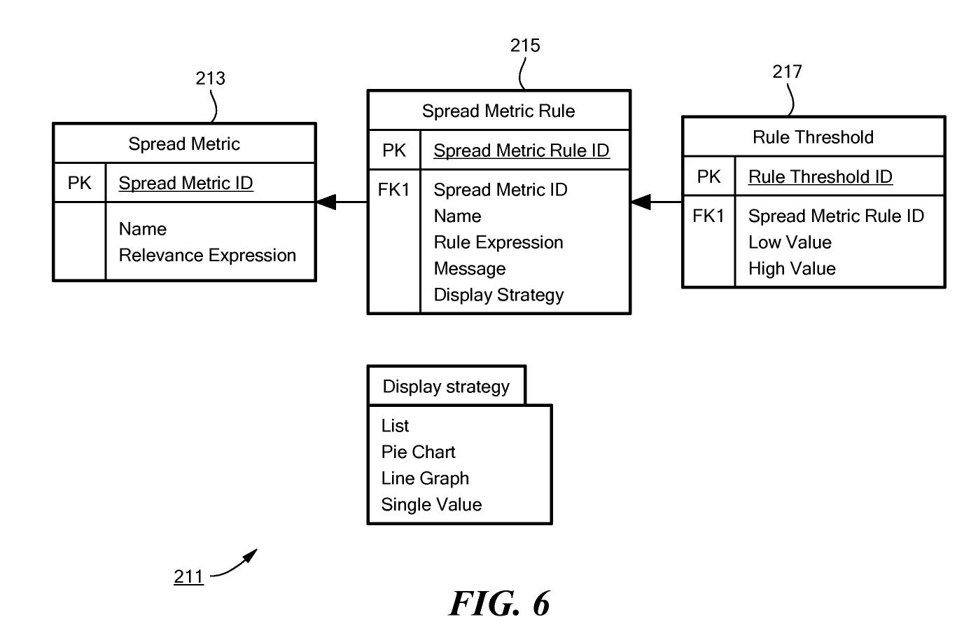

Referring now to FIG. 6, there is shown an exemplary data model supporting the flexible nature of the definition, or rule, associated with each content spread metric as well as the means for executing and displaying the results of each spread metric rule, the data model being identified generally by reference numeral 211. As can be seen, each spread metric table 213 is defined by a plurality of modifiable rules 215, which enables the user to craft spread metrics using thresholds (via threshold table 217) to meet a particular content selection strategy. In turn, each modifiable rule 215 enables the user to establish the preferred means for displaying each executed spread metric rule (e.g., by list, pie chart, line graph and/or single value).

The utilization of spread metric rules by content selection facility 55 requires a multi-stepped process. In the first step of the process, end user 13 selects the relevant spread metrics to be utilized during the content selection process, with the definition of each rule to be run for the metric available for modification, if deemed appropriate. Spread metric table 213 preferably enumerates all spread metrics available to end user 13.

Upon selection of a particular spread metric, a corresponding spread metric rule for the spread metric is rendered available for examination and modification, if necessary. Exemplary pseudocode for defining a spread metric rule is provided below:

return true
If count(article) > 1000

return true

If metric-columns includes-any
(article.author, article.author.institution)

return true

The relevance expression column for each spread metric table 213 contains program code that can be executed against a text mining job definition to return a “true” or “false” value for the relevance of a given spread metric. In other words, based on the first level of the rule provided above, a “true” value denotes that the rule is relevant and should be applied.

In the second level of the rule, the rule parameters are defined. In the present example, it is to be determined whether there are more than 1000 articles in the content spread. The rule is deemed relevant based on aggregate functions executed against the job definition.

In the third level of the rule, the measurement attributes are defined. The aforementioned process is then repeated for every spread metric rule to be run (i.e., each rule that has a relevance expression identified as “true.”

In the second step of the process, all the relevant spread metrics (i.e., metrics to be applied to the content selection process) are retrieved by content selection facility 55 and, in turn, executed in compliance therewith. It should be noted that a given spread metric can incorporate one or more spread metric rules.

The rule expression column contains program code that can be executed against the job definition and its associated collection of documents. Exemplary pseudocode is provided below:

Select article.publication.origin,

count (distinct article.publication.origin)

/count (article)

from job.articles

In the exemplary code provided above, a list of article sources is to be sorted by their percentages of the total population and displayed accordingly. This allows the researcher to determine whether a particular article source is overrepresented in the document collection for a particular job.

Further exemplary pseudocode is provided below:

Select sum(article.publication.price)
from job.articles

In the exemplary code provided above, the total content acquisition price for the articles included in a particular job is displayed to the user.

In the last step of the process, a link is displayed for each executed spread metric so that the user can review the results according to the display strategy set forth in the spread metric rule. As an example, a pie chart display strategy indicates that the rule returns a list of {article name, article value} pairs that can be interpreted as percentages. As another example, a single value display strategy indicates that a rule returns a single value that can be combined with the message attribute (e.g., in the C-language string, “The total cost of the job is % d,” where the % d parameter is replaced for display by the value returned by the rule expression).

It is to be understood that the above-described process of selecting content for a job collection can be achieved using constraint programming or optimization technologies. Accordingly, a practitioner skilled in the art could utilize various mathematical optimization strategies, including simplex, min-max, and nonlinear and iterative methods to optimally select content from document repository 19.

### Illustrative Use of Text Mining System 11 and Method 111

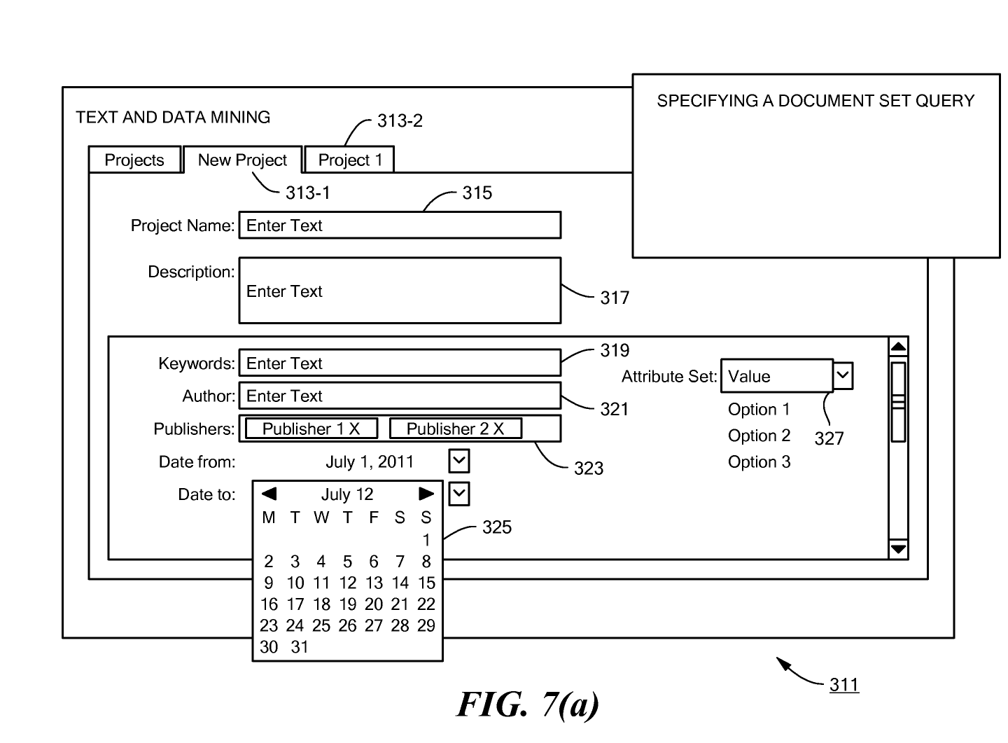

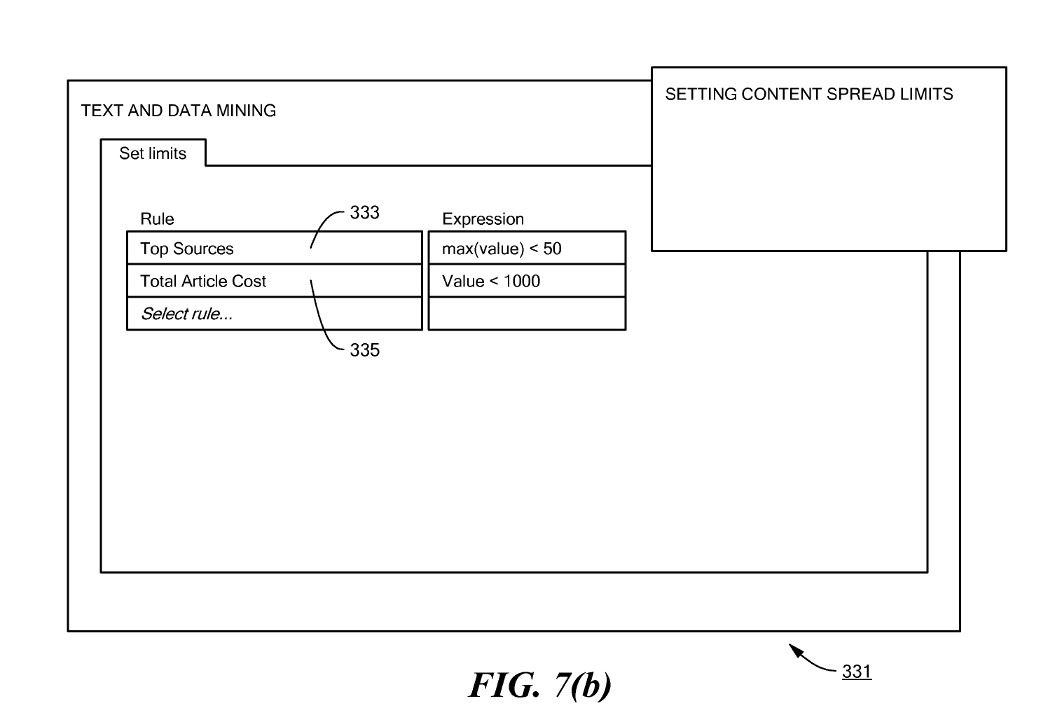

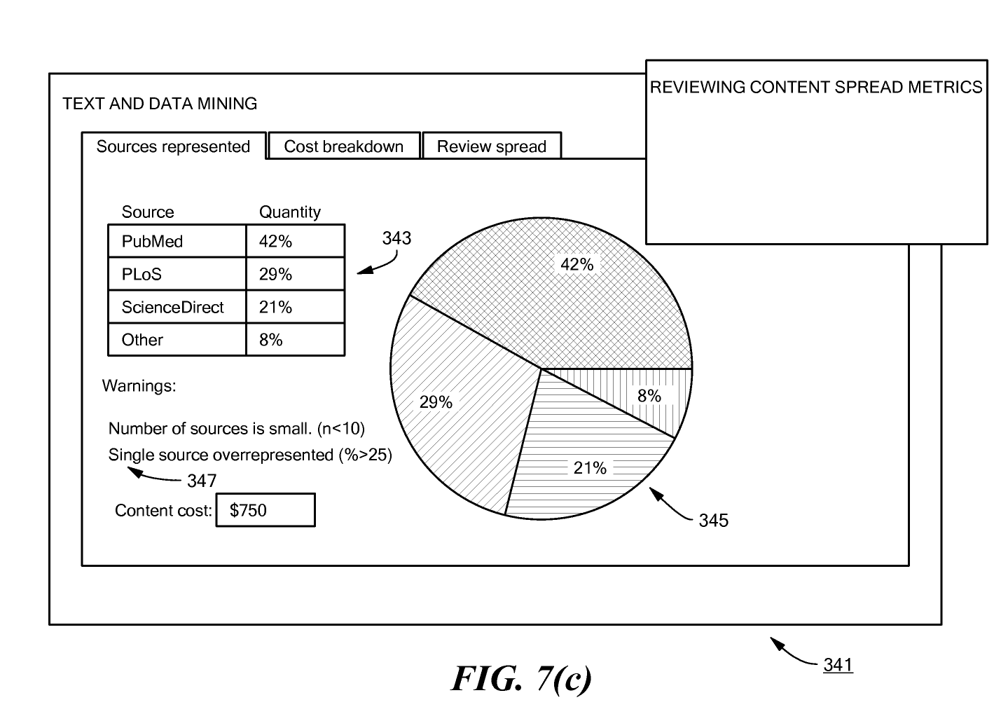

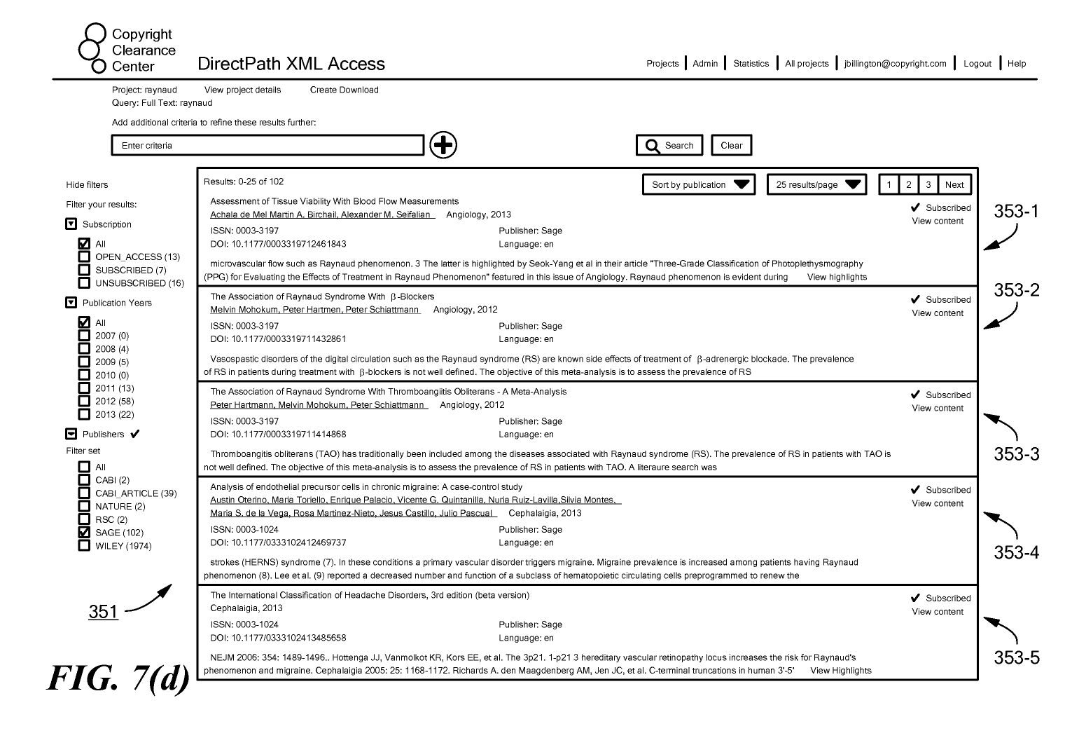

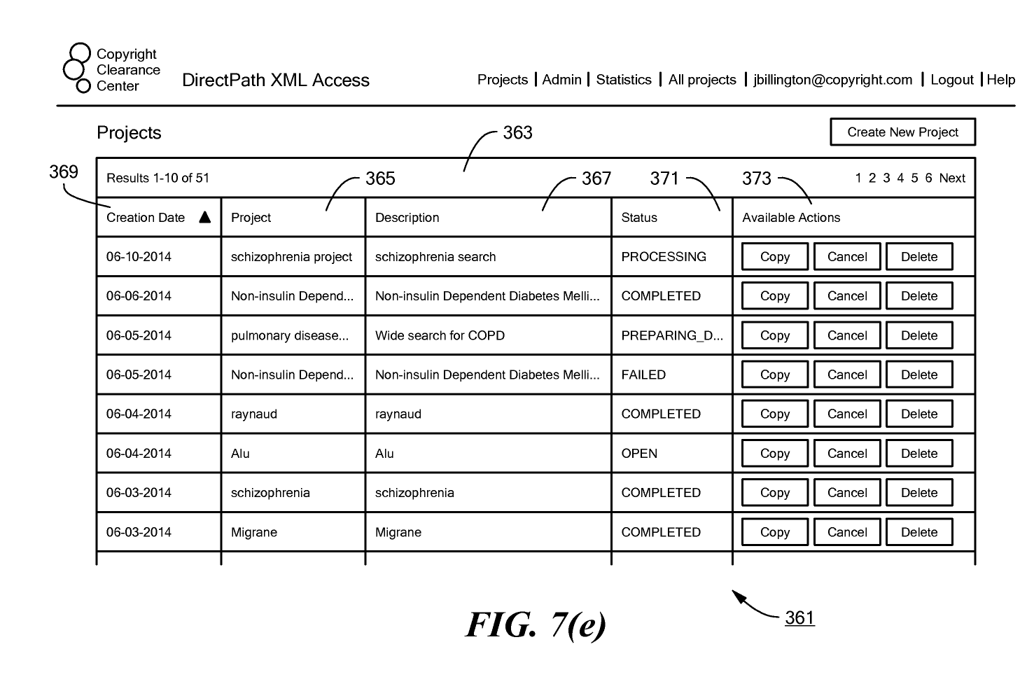

Referring now to FIGS. 7(a)-(e), there is shown a series of sample screen displays which are useful in understanding the principles of the present invention.

As referenced above, first step 113 of method 111 requires end user 13 to define the text mining job. To assist in the selection of articles to be collected in step 115, system 11 generates a user interface for selecting content, an exemplary screen display of the user interface being shown in FIG. 7(a) and identified generally by reference numeral 311.

As can be seen, content selection user interface 311 includes a plurality of tabs 313-1 and 313-2, which provide access to new or previously defined text mining projects. Each project screen includes a project name window 315 for identifying the job, a description window 317 for briefly summarizing the scope of the job, a keyword window 319 for inputting keywords to be used in the content selection process, an author window 321 for either including or withdrawing selected authors from the content selection process, a publisher window 323 for either including or withdrawing selected publishers from the content selection process, and a date window 325 for restricting the content selection process to articles published within a defined time period. Together, the various search parameters, or elements, provided on screen 311 are passed to content selection facility 55 to populate the collection of articles for the text mining job.

It should be noted that content selection user interface 311 is additionally provided with an attribute set dropdown window 327 that enables the user to select and modify a particular text mining processing attribute. For instance, by clicking on the term “value” in window 327, end user 13 is brought to another screen where a search cost cap can be implemented for the text mining operation.

Specifically, referring now to FIG. 7(b), there is shown a sample screen display of a user interface for setting content spread limits, the exemplary screen display being identified generally by reference numeral 331. As can be seen, various cost-related rules can be incorporated into document selection step 115. Through user interface 331, end user 13 can establish cost limits by selecting a rule from a list and, in turn, specifying an expression to be executed against the return value for the rule.

For instance, in a first rule 333, the expression states that the maximum value for the result is to be 50. In other words, no source is to constitute more than 50% of the total article population. During execution of content selection step 115, content selection facility 55 will constrain article selection for the collection to honor the specified limit (i.e., to prevent a content hotspot of a single article). This restriction may, in turn, affect the total number of articles represented in the collection.

In a second rule 335, the expression states that the total article cost computed by the rule may not exceed $1000. During execution of content selection step 115, content selection facility 55 will constrain article selection for the collection to ensure that the total article cost does not exceed this value. This restriction may, in turn, affect both the relative representation of article sources in the collection as well as the total number of articles.

It should be noted that all of the content spread limits for a job must be executed in compliance therewith. For instance, using the examples provided above, selection of content must (i) consist of articles from a variety of sources such that no one source contributes more than 50% of the articles, and (ii) require the expenditure of no more than $1000 to acquire articles that carry a cost of access to the researcher (i.e., articles that do not fall under a user subscription or that are not available to the public for free).

It should also be noted that the rules set forth above are merely examples of possible content spread limit rules. It is to be understood that other types of content spread limit rules could be similarly defined and utilized without departing from the spirit of the present invention.

It should further be noted that although content cost is represented herein in dollars, it is to be understood that a skilled practitioner could add support for costs in international currencies and associated currency conversions without departing from the spirit of the present invention.

Once the various query rules have been defined, content searching facility 55 selects a primary collection of documents to be used for subsequent text mining operations. To enable end user 13 to evaluate the quality of the primary collection of documents prior to text mining, content searching facility 55 generates a UI review screen that provides detailed metrics of the content spread, a sample UI review screen display which is shown in FIG. 7(c) and identified generally as reference numeral 341.

In exemplary screen display 341, the content spread of sources represented is provided as a table, or list, 343 as well as a pie chart 345 that is useful in visualizing the content spread. As can be seen, 42% of the collected content is derived from a single source (PubMed, which is a free source). Furthermore, nearly 70% of the collected content is derived from the top two sources (PubMed and PLoS), both of which are free sources.

In view thereof, user 13 can immediately deduce that the content spread is too narrow (i.e., not enough sources are adequately represented). This observation is supported by warnings 347 that notify to user 15 that (i) the number of sources is small and (ii) a single source is overrepresented.

It may be determined by the user that the content spread is too narrow because, among other things, the budget is too restrictive. As a result, the user may opt to increase the content cost to yield a better spread of content.

It may also be determined by the user that the content spread is too narrow because, among other things, the query is too broad and thereby yields too large of an initial pool of documents. As a result, the user may opt to narrow the scope of the search parameters.

Although the content spread of sources is shown herein, it is to be understood that alternative attributes of content spread (e.g., publication date, title, country of origin, article language, cost breakdown, etc.,) could be similarly provided to user 13 for review. Through this interactive, intuitive process, end user 13 can modify the document population until ultimately an optimized content spread is achieved (e.g., an optimized spread of content that falls within a predefined budget).

Once an optimized content spread is achieved, the processing steps of the text mining operation are performed by text mining processor 19 in accordance with a specified schedule. Upon completion, the resultant bibliographic data is stored as a derived dataset in repository 21. This derived dataset is then available to be retrieved and examined by end user 13 during the course of research via project manager 15.

Specifically, referring now to FIG. 7(d), there is shown a sample screen display of a text mining results list that is identified generally by reference numeral 351. As can be seen, screen display 351 includes information (e.g., bibliographic data, user access cost, synopsis, etc.,) on each of a series of research documents 353-1 thru 353-5 that were identified as part of a text mining project. Additionally, each document provided in the list includes a link for accessing the full text of the article, if available to user 13 either for free or at a determined cost. In this manner, user 13 can effectively access and review pertinent research articles on a specified topic at a user-defined cost, which is a principal object of the present invention.

Periodically, end user 13 can review and monitor the status of various text and data mining projects through an appropriate user interface provided by project manager 15. Specifically, referring now to FIG. 7(e), there is shown a sample screen display of a user interface for the review of current and past text mining projects initiated by end user 13, the exemplary screen display being identified generally by reference numeral 361. In screen display 361, a table 363 of initiated text mining jobs available for a logged in end user 13 of system 11 is shown.

As can be seen, the various projects associated with end user 13 are listed using the project name 365 and description information 367 previously provided by the user via content selection interface 311. In addition, table 363 includes a creation date window 369 for each project as well as a status window 371 to notify the user of the job state (i.e., completed, open, failed, processing, etc.). Furthermore, certain functions can be taken with respect to each job by clicking on one-click action buttons 373.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for facilitating the text mining of a plurality of research documents by a user, the plurality of research documents carrying a non-uniform cost for access by the user, the system comprising:
(a) a content repository adapted to store the plurality of research documents, the content repository being adapted to receive a query from the user to select a primary collection of the plurality of research documents for text mining, the content repository providing content spread metrics relating to the research documents in the primary collection that enables the user to optionally modify the query to yield a final collection of the plurality of research documents that is optimized for the user; and
(b) a text mining processor for text mining the final collection of research documents to produce a derived text mining data set.

2. The system as claimed in claim 1 further comprising a project manager for managing text mining of the plurality of research documents, the project manager electronically linking the content repository and the text mining processor.

3. The system as claimed in claim 2 wherein the project manager provides a computer interface for direct access to the system by the user.

4. The system as claimed in claim 3 wherein the content repository executes the query using in compliance with one or more rules relating to the content spread metrics of the research documents to be collected.

5. The system as claimed in claim 4 wherein the content repository generates a report relating to the content spread metrics of the research documents in the primary collection.

6. The system as claimed in claim 5 wherein the report includes at least one display from the group consisting of a list, a pie chart, a line graph and a single value.

7. The system as claimed in claim 4 wherein the content repository comprises:
(a) a data storage device for storing bibliographic metadata and full text for each of the plurality of research documents; and
(b) a content selection facility for receiving and executing the query, the content selection facility being in electronic communication with the data storage device.

8. The system as claimed in claim 7 wherein the data storage device includes a database of user access rights that enables the content repository to determine an access cost for each of the plurality of research documents to the user.

9. The system as claimed in claim 8 wherein the content selection facility is capable of supporting document access cost parameters into the query.

10. The system as claimed in claim 9 wherein the content selection facility utilizes the user access cost for each of the plurality of research documents in the cost parameters for the query.

11. The system as claimed in claim 10 wherein the content selection facility is capable of supporting document access cost parameters into the query that are defined by the user and that are modifiable.

12. The system as claimed in claim 11 wherein the content selection facility is capable of supporting a maximum user access cost into the query.

13. The system as claimed in claim 5 wherein the content repository provides cost-related content spread metrics in the report for the research documents in the primary collection of the research documents.

14. The system as claimed in claim 1 wherein the content selection facility cross-references and stores the final collection of research documents retrieved in response to the query to facility future text mining operations.

15. The system as claimed in claim 1 wherein the text mining processor performs text mining of the final collection of research documents using parallel clusters of similar data structures.

16. The system as claimed in claim 15 wherein the text mining processor includes application programming interfaces for developing both standard and custom text mining processing modules.

17. The system as claimed in claim 1 further comprising a derived data repository in communication with the text mining processor, the derived data repository storing the derived text mining data set.
